(19) United States
(12) Patent Application Publication
(10) Pub. No.: US 2015/0309678 A1
(43) Pub. Date: Oct. 29, 2015

(54) METHODS AND APPARATUS FOR RENDERING A COLLECTION OF WIDGETS ON A MOBILE DEVICE DISPLAY

(71) Applicant: SPB SOFTWARE INC., Hackensack, NJ (US)

(72) Inventors: Vasily FILIPPOV, Saint-Petersburg (RU); Yaroslav GONCHAROV, Sosnovy Bor (RU)

(21) Appl. No.: 14/792,040

(22) Filed: Jul. 6, 2015

Related U.S. Application Data
(63) Continuation of application No. 12/701,044, filed on Feb. 5, 2010, now abandoned.

(51) Int. Cl. G06F 3/0482; G06F 3/0484

(52) U.S. Cl. CPC G06F 3/0482; G06F 3/04847; G06F 3/04842

(57) ABSTRACT

A system renders a collection of widgets on a mobile device display by identifying a first appearance and a second appearance associated with a respective rendering of a first and second collection of widgets on the mobile device display. The system transitions from the rendering of the first collection to the second. The system receives notification to transition the collection of widgets on the mobile device display from a two-dimensional presentation to a three-dimensional presentation. The system renders a native widget on the mobile device display utilizing a native interface by identifying a non-native widget requiring a non-native interface to operate on the mobile device display. The system provides a proxy widget to host the non-native widget allowing the non-native widget to operate on the mobile device display utilizing the native interface.

### BACKGROUND

Smart phones are mobile devices with Personal Computer (PC) like features, including an operating system, software applications, a miniature QWERTY keyboard, touch screen, etc. Smart phones run various software applications, such as email clients, and provide Internet access. These software applications, often referred to as ‘widgets’, can be installed and executed on mobile devices without additional compilation. Given the size of the touch screen, only a subset of the widgets can be rendered on the touch screen at any given time. Yet, there may be many widgets available to the user. Therefore, it is necessary to organize the widgets to facilitate the user's ability to quickly locate and execute the desired widgets. Typically, the widgets are grouped together and rendered on panels or screens. For example, widgets related to the Internet might be grouped together on one panel or screen. Other widgets related to system clocks, calendars, national and international time differences might be grouped together on another panel or screen. This organization provides convenience and efficiency to users by making it easier for users to locate these widgets.

### SUMMARY

Conventional computerized technologies for rendering widgets on a communications device, such as a smart phone, suffer from a variety of deficiencies. In particular, conventional technologies for rendering widgets are limited in that conventional technologies typically provide collections of widgets (i.e., a grouping of widgets rendered together on the same screen or panel) with similar colored backgrounds, making it difficult for the user to distinguish between screens when several screens are rendered simultaneously on the mobile device display. Conventional technologies do not provide seamless transitioning from one screen to another screen. Conventional technologies often render collections of widgets in a two-dimensional representation that appear to be a three-dimensional representation when viewed frontally, but the three-dimensional illusion disappears when the two-dimensional representation is viewed from an angle. Conventional technologies for rendering widgets do not provide an interface that allows native widgets to operate in conjunction with non-native widgets.

Embodiments disclosed herein significantly overcome such deficiencies and provide a system that includes a computer system and/or software executing a widget rendering process that renders a collection of widgets on a mobile device display. Widgets may be standalone applications that may be hosted by a widget system (i.e., a software service available to users for running the widgets on a graphical user interface). For example, a widget system (host) may control the placement of the widget on the mobile device display, but typically does not control its content. A widget system may host several widgets on the same page/screen of the mobile device display. Widgets may be focused applications that are generally smaller in size, and less complex than typical software applications. Widgets often take up little real estate on a display when operating. Widgets may be written in a variety of different languages.

The widget rendering process may provide, for example, a predominant color or appearance to each collection of widgets (i.e., screens or panels), and provides a seamless transition between collections of widgets when a user scrolls between collection of widgets on the mobile device display (for example, when a user utilizes panoramic scrolling on the mobile device display). As the user scrolls from one collection of widgets (i.e., a screen) to the next, the background morphs from the background of the first screen to the background of the second screen. The background is spanned into several pages as the user scrolls from the first screen to the second screen to create the morphine effect. The widget rendering process provides the seamless transition by identifying a first appearance, for example, a first color, associated with a rendering of a first collection of widgets on the mobile device display, and identifying a second appearance, for example, a second color, associated with a rendering of a second collection of widgets on the mobile device display. It should be noted that while each respective color/appearance is associated with a rendering of a respective collection of widgets, the background is separate from the widgets and would still be rendered even if all the widgets were removed from the respective collection. The widget rendering process transitions from the rendering of the first collection of widgets on the mobile device display to the rendering of the second collection of widgets on the mobile device display. During the transitioning, the widget rendering process renders a transformation from the first appearance to the second appearance on the mobile device display. The transformation renders a plurality of appearances ranging from the first appearance to the second appearance on the mobile device display where each of the plurality of appearances includes a varying combination of the first appearance and the second appearance. In other words, as the user scrolls through screens panoramically on the mobile device display, the widget rendering process renders a seamless transition from the appearance of a first screen to the appearance of the second screen. The blending of the two appearances is smooth. In an example embodiment, during panoramic scrolling, the actually width of the screen is wider than the width of the mobile device display creating the appearance of panoramic scrolling. In an example embodiment, the steps of identifying a first appearance, identifying a second appearance, and transitioning from the first appearance to the second color are performed for each pixel on the mobile device display.

In an example embodiment, the widget rendering process renders the plurality of collections of widgets in the formation of a carousel where at least a first collection of widgets is visible in the front of the carousel and at least a second collection of widgets is visible in the back of the carousel concurrently with the first collection of widgets.

In an example embodiment, the widget rendering process renders each of the plurality of collections of widgets with an associated color/appearance. In another example embodiment, the widget rendering process allows the user to choose the associated color/appearance rendered with at least one of each of the plurality of collections of widgets.

In an example embodiment, the widget rendering process performs the transitioning in a panoramic view where a portion of the rendering of the first collection of widgets on the mobile device display is rendered concurrently with a portion of the rendering of the second collection of widgets on the mobile device display. In other words, the user views a gradual, seamless transition between a first screen and a second screen during the panoramic scrolling. In an example embodiment, the actual transition between the first screen and the second screen is imperceptible to the user, and the appearance of the first screen morphs into the appearance of the second screen as the user scrolls through the screens panoramically.

In an example embodiment, the widget rendering process receives notification to transition the collection of widgets on the mobile device display from a two-dimensional presentation to a three-dimensional presentation where the two-dimensional presentation comprises two-dimensional representations of widgets rendered with a canvas on the mobile device display. The widget rendering process replaces each of the two-dimensional representations of widgets in the collection of widgets with a respective three-dimensional representation of a widget in the collection of widgets. The widget rendering process presents the collection of widgets on mobile device display as the three-dimensional presentation by rendering the three-dimensional representations of widgets with the canvas. In other words, when the two-dimensional representation transitions to a three-dimensional representation, a user may view the three-dimensional representation from a side angle and still see the three-dimensional representation. The widget rendering process may also render the collection of widgets three dimensionally on the mobile device display.

In an example embodiment, the widget rendering process renders a plurality of collections of widgets three dimensionally on the mobile device display. In other words, multiple three-dimensional screens are rendered on the mobile device display. A user may manipulate the multiple three-dimensional screens on the mobile device display three dimensionally. Thus, each individual collection of widgets is rendered three dimensionally, and the collections of widgets are rendered three dimensionally. In other words, each screen is rendered three dimensionally, and multiple screens are arranged three dimensionally on the mobile device display. In an example embodiment, a user may also manipulate the screens three dimensionally (i.e., scrolling through the screens, selecting a screen, etc.).

In an example embodiment, the transition from the two-dimensional representation to the three-dimensional representation may occur when the mobile device is shaken, or when a user selects a menu option on the mobile device display to “zoom out” (i.e., transition the view of one collection of widgets to multiple collections of widgets). This transition may also occur when the collections of widgets are rendered on the mobile device display in the formation of a carousel where some of the collections of widgets are visible in the front of the carousel and some of the collections of widgets is visible in the back of the carousel concurrently with the collections of widgets visible in the front of the carousel. The transition may also occur when a user tilts the mobile device display to view additional collection of widgets. In other words, by tilting the angle at which the mobile device is held, the collections of widgets rendered on the mobile device display is rendered three dimensionally with respect to the angle at which the user tilted the mobile device, and additional collections of widgets are rendered on the mobile device display. Thus, the user can see some of the screens on the mobile device display. When the user tilts the mobile device, the carousel of screens rendered on the mobile device display also tilts with respect to the user's movement and the user can see additional screens in the carousel.

In an example embodiment, the widget rendering process detects a relative change in a spatial position of the mobile device, and adjusts the plurality of collections of widgets rendered on the mobile device display three dimensionally with respect to the relative change in the spatial position of the mobile device. For example, a user may view a collection of widgets frontally, but by rotating the mobile device to view the screen of the mobile device at an angle, the collection of widgets rendered on the mobile device display is also rotated such that the user now has a side view of the three-dimensional representation of collection of widgets.

In an example embodiment, the widget rendering process replaces the two-dimensional representation of the widget in the collection of widgets with a respective three-dimensional representation by identifying a two-dimensional image associated with a two-dimensional representation of a widget, and transmitting instructions to the widget to render the two-dimensional image on a three-dimensional object. In another example embodiment, the widget rendering process transmits instructions to the widget to render a three-dimensional model of the two-dimensional image. The widget rendering process renders the three-dimensional representations of widgets at a spatial distance from a rendering of the canvas on the mobile device display.

In an example embodiment, the widget rendering process renders a native widget on the mobile device display utilizing a native interface. The widget rendering process identifies a non-native widget requiring a non-native interface to operate on the mobile device display, and provides a proxy widget to host the non-native widget. This allows the non-native widget to operate on the mobile device display utilizing the native interface. In an example embodiment, the widget rendering process identifies that concurrent operation of the non-native interface and the native interface as incompatible when rendering the collection of widgets on the mobile device display. The widget rendering process identifies a compliance factor associated with the non-native widget that requires use of a non-native interface to execute the non-native widget. For example, W3C compliant widgets (i.e., non-native widgets) operate across several mobile device platforms making them versatile. However, they can have poor performance and functionality. Native widgets (written in the language of the platform of the mobile device on which native widgets execute) provide more functionality. Non-native widgets and native widgets each need their own interface to operate. Typically, there is a trade off between performance and compliance as only one interface can operate on the mobile device. In an example embodiment, the widget rendering process implements a native layer that hosts the non-native widget. This allows the non-native widget to operate as though it were a native widget. The non-native widget can now operate in conjunction with native widgets via the native interface. The benefit is that web developers can implement powerful widgets for mobile devices, mobile device providers can provide widgets that are compliant across multiple platforms, and users get the best of both worlds accessing a wider variety of widgets on their mobile devices.

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained as embodiments disclosed herein.

It is to be understood that the system disclosed herein may be embodied strictly as a software program, as software and hardware, or as hardware alone. The embodiments disclosed herein, may be employed in data communications devices and other computerized devices and software systems for such devices such as those manufactured by Spb Software, Inc. of Hackensack, N.J.

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a high-level block diagram of a computer system according to one embodiment disclosed herein.

FIG. 2 shows an example screenshot of a collection of widgets.

FIG. 3 shows another example screenshot of a collection of widgets.

FIG. 4 shows an example screenshot of a collection of widgets rendered in the formation of a carousel.

FIG. 5 shows an example embodiment of a first collection of widgets transitioning to a second collection of widgets during panoramic scrolling.

FIG. 6 is an example screenshot of a mobile device display rendering a two-dimensional representation of a collection of widgets.

FIG. 7 is an example screenshot of a two-dimensional representation of a collection of widgets.

FIG. 8 is an example screenshot of a two-dimensional collection of widgets rendered from an angle.

FIG. 9 is an example screenshot of a three-dimensional collection of widgets rendered from an angle.

FIG. 10 is an example screenshot of a plurality of collection of widgets rendered three dimensionally.

FIG. 11 is an example screenshot of a user manipulating a plurality of collection of widgets three dimensionally.

FIG. 12 is an example screenshot of a user selecting one of the pluralities of collections of widgets.

FIG. 13 is an example screenshot of the widget rendering process rendering the collection of widgets selected by a user.

FIG. 14 illustrates a flowchart of a procedure performed by the system of FIG. 1, when the widget rendering process identifies a first color/appearance associated with a rendering of a first collection of widgets on the mobile device display, according to one embodiment disclosed herein.

FIG. 15 illustrates a flowchart of a procedure performed by the system of FIG. 1, when the widget rendering process, during the transitioning, renders a transformation from the first color/appearance to the second color/appearance on the mobile device display, according to one embodiment disclosed herein.

FIG. 16 illustrates a flowchart of a procedure performed by the system of FIG. 1, when the widget rendering process transitions from the rendering of the first collection of widgets on the mobile device display to the rendering of the second collection of widgets on the mobile device display, according to one embodiment disclosed herein.

FIG. 17 illustrates a flowchart of a procedure performed by the system of FIG. 1, when the widget rendering process receives notification to transition the collection of widgets on the mobile device display from a two-dimensional presentation to a three-dimensional presentation, according to one embodiment disclosed herein.

FIG. 18 illustrates a flowchart of a procedure performed by the system of FIG. 1, when the widget rendering process renders a plurality of collections of widgets three dimensionally on the mobile device display, according to one embodiment disclosed herein.

FIG. 19 illustrates a flowchart of a procedure performed by the system of FIG. 1, when the widget rendering process receives notification to transition the collection of widgets on the mobile device display from a two-dimensional presentation to a three-dimensional presentation, and renders the collection of widgets in the formation of a carousel, according to one embodiment disclosed herein.

FIG. 20 illustrates a flowchart of a procedure performed by the system of FIG. 1, when the widget rendering process replaces each of the two-dimensional representations of widgets in the collection of widgets with a respective three-dimensional representation of a widget in the collection of widgets, according to one embodiment disclosed herein.

FIG. 21 illustrates a flowchart of a procedure performed by the system of FIG. 1, when the widget rendering process presents the collection of widgets on mobile device display as the three-dimensional presentation by rendering the three-dimensional representations of widgets with the canvas, according to one embodiment disclosed herein.

FIG. 22 illustrates a flowchart of a procedure performed by the system of FIG. 1, when the widget rendering process renders a native widget on the mobile device display utilizing a native interface, according to one embodiment disclosed herein.

### DETAILED DESCRIPTION

Embodiments disclosed herein include a computer system executing a widget rendering process that renders a collection of widgets on a mobile device display. The widget rendering process may provide a predominant color/appearance to each collection of widgets (i.e., screens or panels), and provide a seamless transition between collections of widgets when a user scrolls between collections of widgets on the mobile device display (for example, when a user utilizes panoramic scrolling on the mobile device display). The widget rendering process provides the seamless transition by identifying a first color/appearance associated with a rendering of a first collection of widgets on the mobile device display, and identifying a second color/appearance associated with a rendering of a second collection of widgets on the mobile device display. The widget rendering process transitions from the rendering of the first collection to the second collection of widgets on the mobile device display.

In an example embodiment, the widget rendering process renders the plurality of collections of widgets in the formation of a carousel where at least a first collection of widgets is visible in the front of the carousel and at least a second collection of widgets is visible in the back of the carousel concurrently with the first collection of widgets.

In an example embodiment, the widget rendering process performs the transitioning in a panoramic view where a portion of the rendering of the first collection of widgets on the mobile device display is rendered concurrently with a portion of the rendering of the second collection of widgets on the mobile device display.

In an example embodiment, the widget rendering process receives notification to transition the collection of widgets on the mobile device display from a two-dimensional presentation to a three-dimensional presentation. The two-dimensional presentation comprises two-dimensional representations of widgets rendered with a canvas on the mobile device display. The widget rendering process replaces each of the two-dimensional representations of widgets in the collection of widgets with a respective three-dimensional representation of a widget in the collection of widgets. The widget rendering process presents the collection of widgets on mobile device display as the three-dimensional presentation by rendering the three-dimensional representations of widgets with the canvas.

In an example embodiment, the widget rendering process renders a native widget on the mobile device display utilizing a native interface. The widget rendering process identifies a non-native widget requiring a non-native interface to operate on the mobile device display, and provides a proxy widget to host the non-native widget that allows the non-native widget to operate on the mobile device display utilizing the native interface.

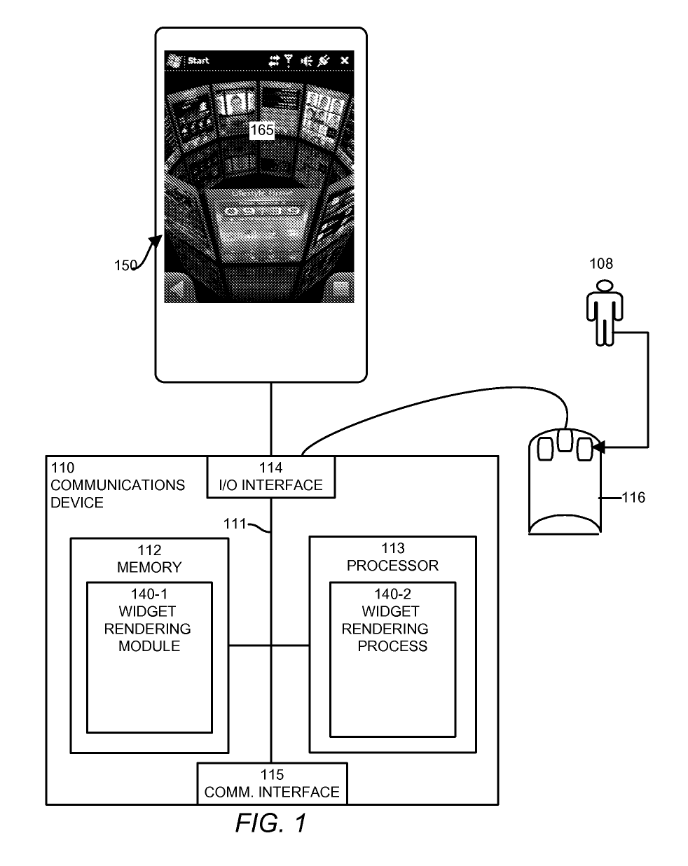

FIG. 1 is a block diagram illustrating example architecture of a mobile device 110 that executes, runs, interprets, operates or otherwise performs a widget rendering module 140-1 and widget rendering process 140-2 suitable for use in explaining example configurations disclosed herein. The mobile device 110 may be any type of computerized device such as a personal computer, workstation, portable computing device, console, laptop, network terminal or the like. An input device 116 (e.g., one or more user/developer controlled devices such as a keyboard, mouse, touch screen, etc.) couples to processor 113 through I/O interface 114, and enables a user 108 to provide input commands, and generally control a graphical user interface that the widget rendering module 140-1 and process 140-2 provides on the mobile device display 150 (rendering a carousel 165). As shown in this example, the mobile device 110 includes an interconnection mechanism 111 such as a data bus or other circuitry that couples a memory system 112, a processor 113, an input/output interface 114, and a communications interface 115. The communications interface 115 enables the mobile device 110 to communicate with other devices (i.e., other computers) on a network (not shown).

The memory system 112 is any type of computer readable medium, and in this example, is encoded with a widget rendering module 140-1 as explained herein. The widget rendering module 140-1 may be embodied as software code such as data and/or logic instructions (e.g., code stored in the memory or on another computer readable medium such as a removable disk) that supports processing functionality according to different embodiments described herein. During operation of the mobile device 110, the processor 113 accesses the memory system 112 via the interconnect 111 in order to launch, run, execute, interpret or otherwise perform the logic instructions of a widget rendering module 140-1. Execution of a widget rendering module 140-1 in this manner produces processing functionality in widget rendering process 140-2. In other words, the widget rendering process 140-2 represents one or more portions or runtime instances of a widget rendering module 140-1 (or the entire a widget rendering module 140-1) performing or executing within or upon the processor 113 in the mobile device 110 at runtime.

It is noted that example configurations disclosed herein include the widget rendering module 140-1 itself (i.e., in the form of un-executed or non-performing logic instructions and/or data). The widget rendering module 140-1 may be stored on a computer readable medium (such as a floppy disk), hard disk, electronic, magnetic, optical, or other computer readable medium. A widget rendering module 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of a widget rendering module 140-1 in the processor 113 as the widget rendering process 140-2. Those skilled in the art will understand that the mobile device 110 may include other processes and/or software and hardware components, such as an operating system not shown in this example.

The widget rendering module 140-1 can be executed on a remotely accessible computerized device via the network interface 115. In this instance, the mobile device display 150 may be displayed locally to a user 108 of the remote computer, and execution of the processing herein may be client-server based.

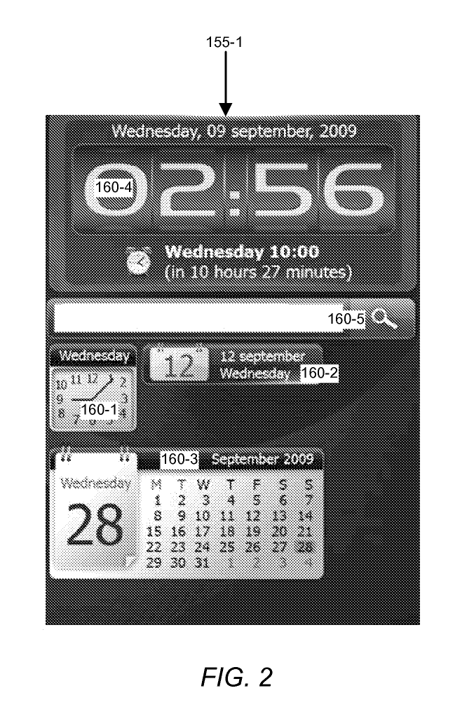

FIG. 2 is an example screenshot of a collection of widgets 155-1 rendering a plurality of widgets 160-1, 160-2, 160-3, 160-4, and 160-5. A common technique for rendering widgets 160-N two dimensionally is to render the background (on which the widgets 160-N are rendered) moving at a slower speed than the rate at which the widgets 160-N move. This technique creates an illusion that the widgets 160-N are rendered three dimensionally on the mobile device display 150 when viewed frontally.

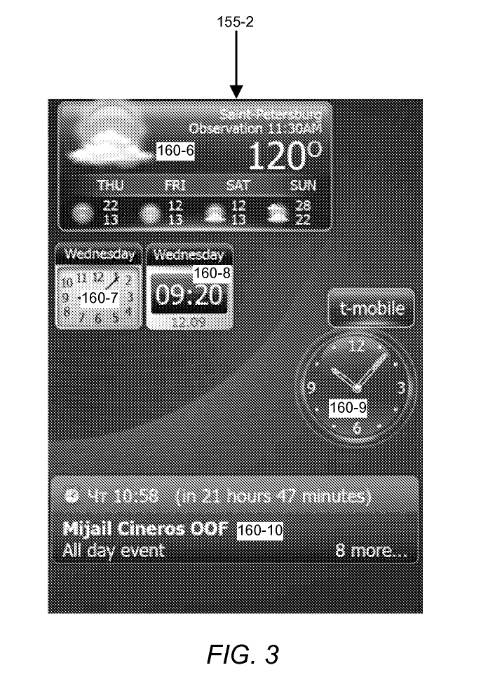

FIG. 3 is another example screenshot of a collection of widgets 155-2 rendering a plurality of widgets 160-6, 160-7, 160-8, 160-9, and 160-10. Often, for the convenience of the user 108 (not shown) to efficiently locate the widgets 160-N, the widgets 160-N are grouped together according to similarity. For example, FIG. 3 depicts a grouping of widgets 160-N related to calendars and clocks.

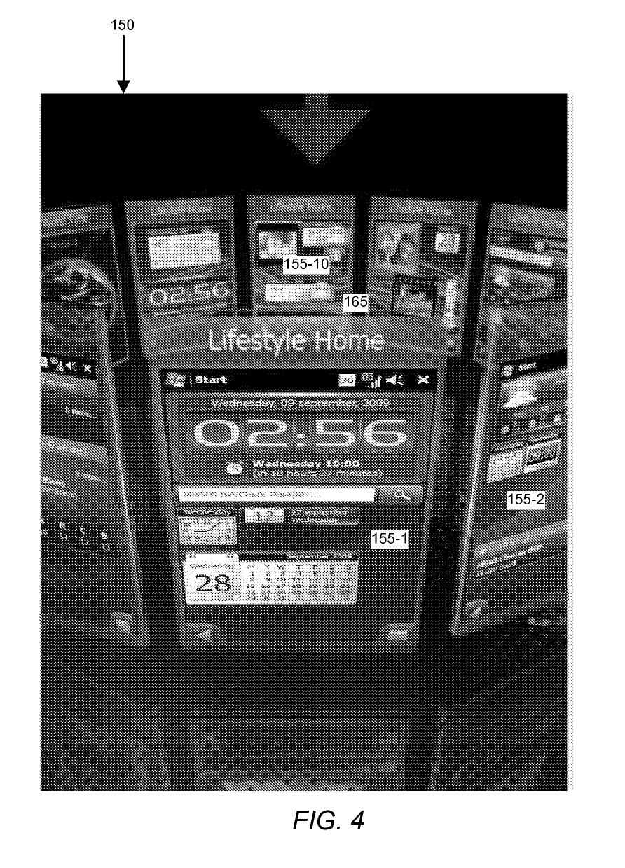

FIG. 4 is an example screenshot of collections of widgets 155-N rendered in the formation of a carousel 165. The carousel 165 is comprised of collections of widgets 155-N. The user 108 (not shown) may spin the carousel 165 to view other collections of widgets 155-N, for example, the collection of widgets 155-2. The user may tap on the mobile device display 150 at the location of any collection of widgets 155-1 to invoke that collection of widgets 155-1. The user may also tilt the mobile device 110 to view additional collections of widgets 155-N. By tilting the mobile device 110, the carousel 165 is rendered three dimensionally on the mobile device display 150, according to a change in spatial position of the mobile device 110. The user 108 is able to look inside the carousel 165 to view the collections of widgets 155-N that are located in the back of the carousel 165, along with the collections of widgets 155-N that are located in the front of the carousel 165. In an example embodiment, the collections of widgets 155-N located in the back of the carousel 165 are rendered on the mobile device display 150 as minor images. In another example embodiment, the collections of widgets 155-N located in the back of the carousel 165 are not rendered on the mobile device display 150 as mirror images. In other words, the user 108 views the collections of widgets 155-N in the back of the carousel, and is able to read them left to right.

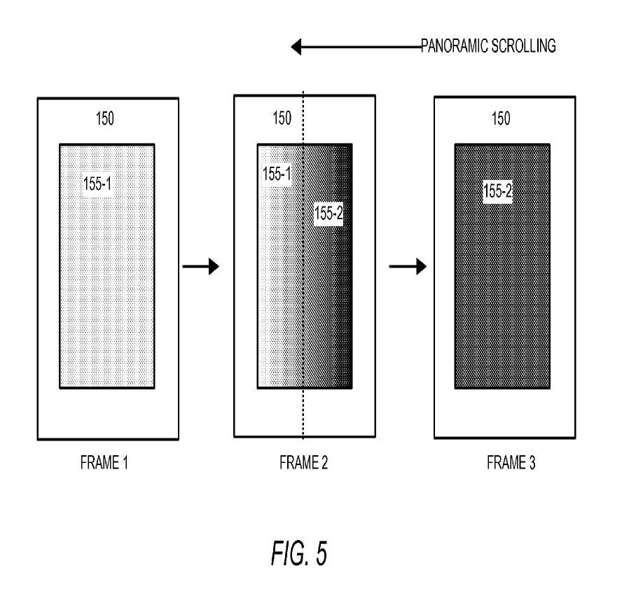

FIG. 5 is an example screenshot of the widget rendering process 140-2 transitioning the rendering of a first collection of widgets 155-1 on the mobile device display 150 to a second collection of widgets 155-2 during panoramic scrolling. As a user 108 (not shown) scrolls the mobile device display 150 from right to left, the mobile device display 150 renders a first collection of widgets 155-1 (Frame 1), a gradual transitioning displaying both the first collection of widgets 155-1 and the second collection of widgets 155-2 (Frame 2), and finally the second collection of widgets 155-2 is rendered on the mobile device display 150 (Frame 3). During the transitioning, the widget rendering process 140-2 renders a transformation from a first color/appearance (of the first collection of widgets 155-1) to a second color/appearance (of the second collection of widgets 155-2). During the transitioning, a plurality of colors/appearances is rendered on the mobile device display 150 wherein each of the plurality of colors/appearances includes varying combinations of the first color/appearance and the second color/appearance. The resulting effect is a gradual morphing from the first collection of widgets 155-1 to the second collection of widgets 155-2 including a morphing from the first color/appearance to the second color/appearance.

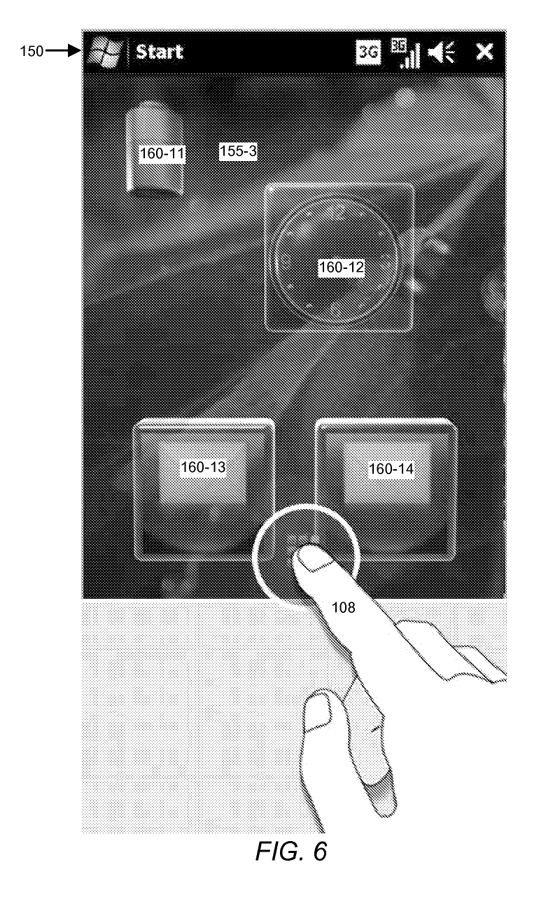

FIG. 6 is an example screenshot of a mobile device display 150 rendering a two-dimensional representation of a collection of widgets 155-3 including widgets 160-11, 160-12, 160-13, and 160-14. A user 108 may select an option on the mobile device display 150 to ‘zoom out’ and view additional collections of widgets 155-N and/or to view one or more collection of widgets 155-3 in a three-dimensional representation.

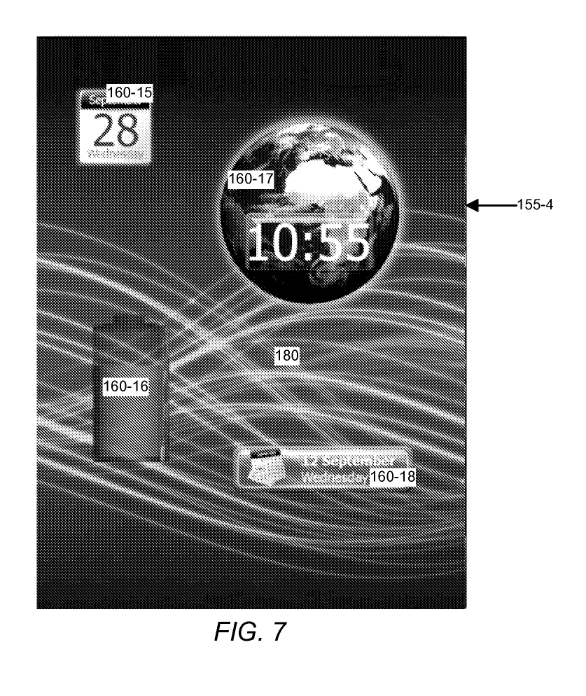

FIG. 7 is an example screenshot of a collection of widgets 155-4 rendered two dimensionally. The collection of widgets 155-4 includes widgets 160-15, 160-16, 160-17 and 160-18. The two-dimensional representation of the collection of widgets 155-4 is comprised of a plurality of two-dimensional widgets 160-N (i.e., 160-15, 160-16, 160-17 and 160-18) rendered on a canvas 180. The two-dimensional representation gives an illusion of being three-dimensional because the plurality of two-dimensional widgets 160-N moves at a rate slower than the canvas 180.

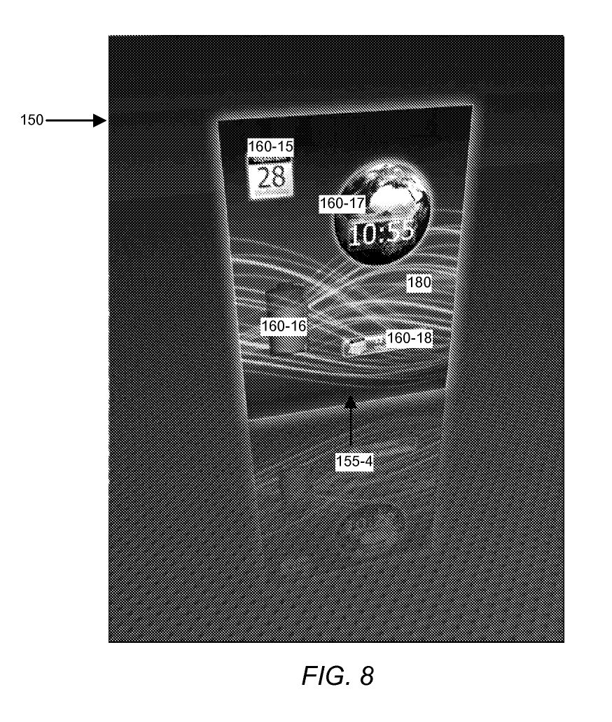

FIG. 8 is an example screenshot of a mobile device display 150 rendering a two-dimensional representation collection of widgets 155-4 including widgets 160-15, 160-16, 160-17 and 160-18 rendered on a canvas 180. The two-dimensional representation of the collection of widgets 155-4 contains two-dimensional widgets 160-N that appear as three-dimensional objects when viewed frontally. However, this illusion disappears when the collection of widgets 155-4 is viewed at an angle as depicted in FIG. 8. The widgets 160-15, 160-16, 160-17 and 160-18 appear flat when the collection of widgets 155-4 is rotated, and viewed at an angle.

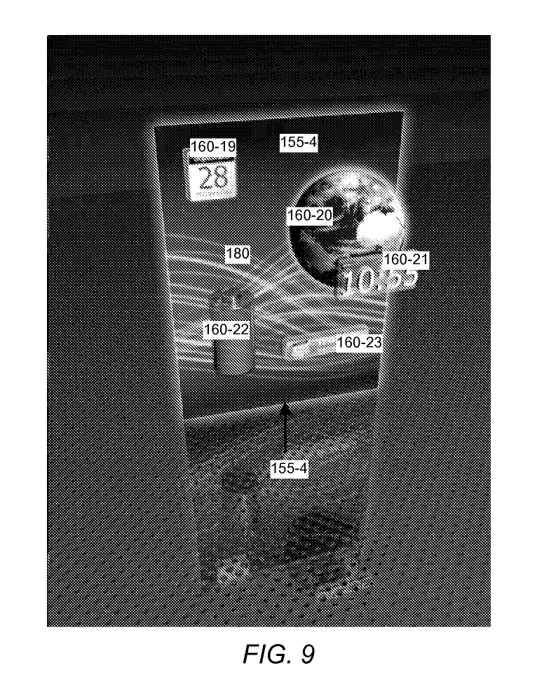

FIG. 9 is an example screenshot of a mobile device display 150 rendering a three-dimensional representation collection of widgets 155-4 including widgets 160-19, 160-20, 160-21, 160-22 and 160-23 rendered on a canvas 180. The three-dimensional representation of the collection of widgets 155-3 contains three-dimensional widgets 160-N that appear as three-dimensional objects when collection of widgets 155-4 is rotated, and viewed at an angle. In an example embodiment, a user 108 can rotate the mobile device display 150, and view the collection of widgets 155-4 from an angle. As the user 108 rotates the mobile device display 150, the user 108 observes that the collections of widgets 155-N are three-dimensional objects rendered at a distance from the canvas 180.

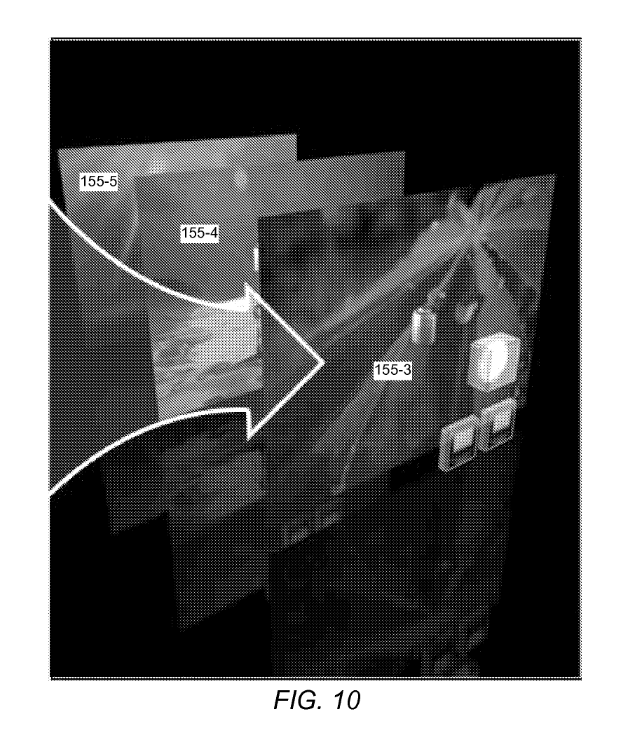

FIG. 10 is an example screenshot of a plurality of collection of widgets 155-3, 155-4, and 155-5, each of which is individually rendered three dimensionally. The plurality of collections of widgets 155-N is also rendered three dimensionally. The widget rendering process 140-2 allows a user 108 to manipulate the plurality of collections of widgets 155-N three dimensionally. For example, the user 108 may scroll through each of the plurality of collections of widgets 155-N. As a user 108 scrolls through the plurality of collections of widgets 155-N, individual collection of widgets 155-N enter and exit the mobile device display 150 three dimensionally.

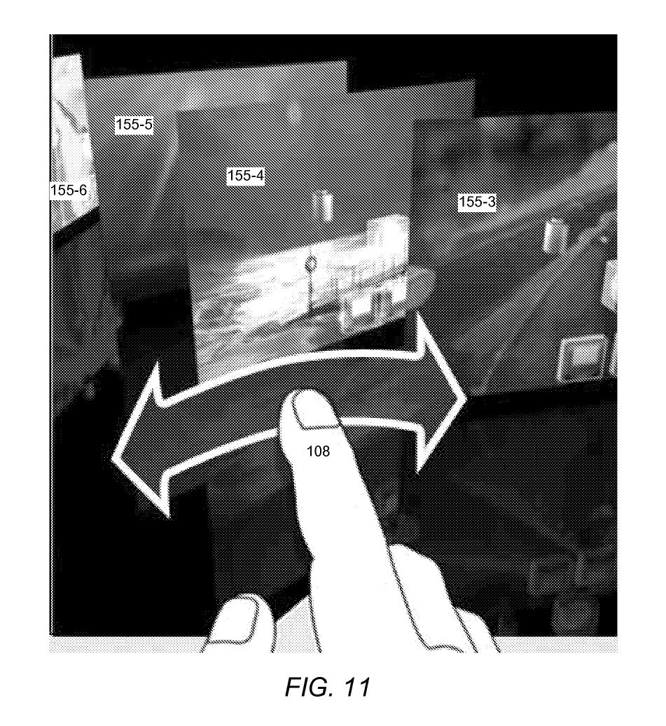

FIG. 11 is an example screenshot of a plurality of collection of widgets 155-3, 155-4, 155-5, and 155-6 each of which is rendered three dimensionally. A user 108 may scroll through the plurality of collections of widgets 155-N to view and/or select any of the collection of widgets 155-N. For example, a user 108 may scroll through the plurality of collections of widgets 155-N by dragging a finger across the mobile device display 150.

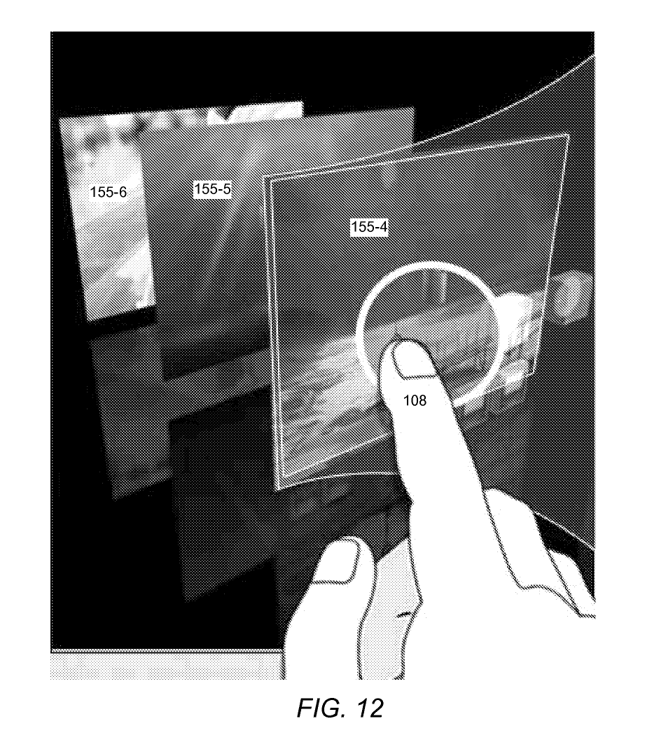

FIG. 12 is an example screenshot of a plurality of collection of widgets 155-4, 155-5, and 155-6 each of which is individually rendered three dimensionally. The plurality of collections of widgets 155-N is also rendered three dimensionally on the mobile device display 150. In an example embodiment, a user 108 may select a collection of widgets 155-4 by tapping on the touch pad of the mobile device display 150.

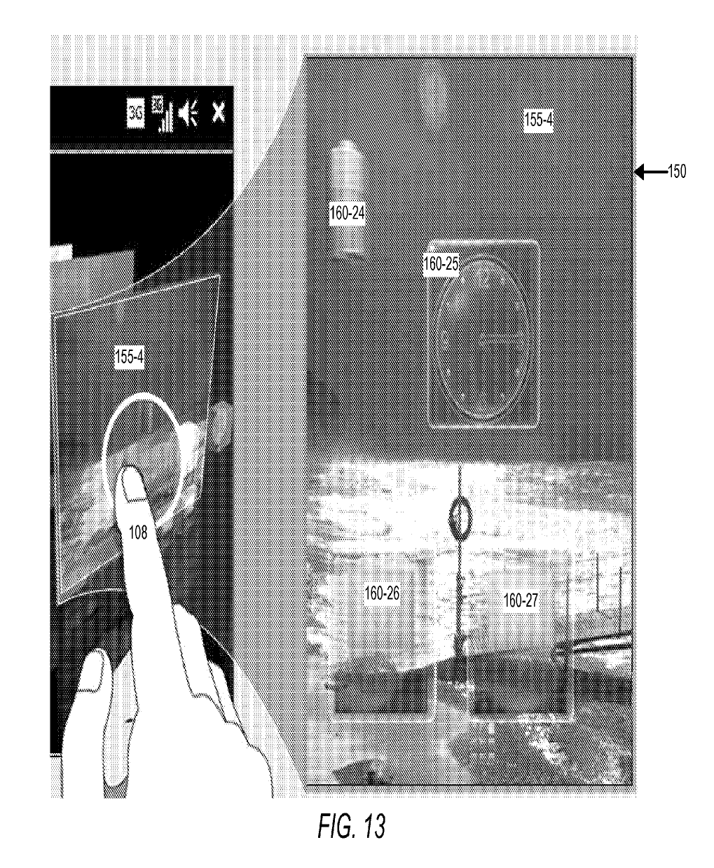

FIG. 13 is an example screenshot of a user 108 selecting a collection of widgets 155-4 by tapping on the touch pad of the mobile device display 150. The widget rendering process 140-2 switches from the three-dimensional representation of the plurality of collections of widgets 155-N to a two-dimensional representation of the selected collection of widgets 155-4. The widget rendering process 140-2 renders a two-dimensional representation of the collection of widgets 155-4 on the mobile device display 150, allowing the user 108 to select any of the widgets 160-N on the collection of widgets 155-4 rendered on the mobile device display 150. The collection of widgets 155-4 includes widgets 160-24, 160-25, 160-26, and 160-27. Thus, a user 108 may easily, and quickly switch between a two-dimensional representation and a three-dimensional representation of collection of widgets 155-4.

Further details of configurations explained herein will now be provided with respect to a flow chart of processing steps that show the high level operations disclosed herein to perform the widget rendering process 140-2.

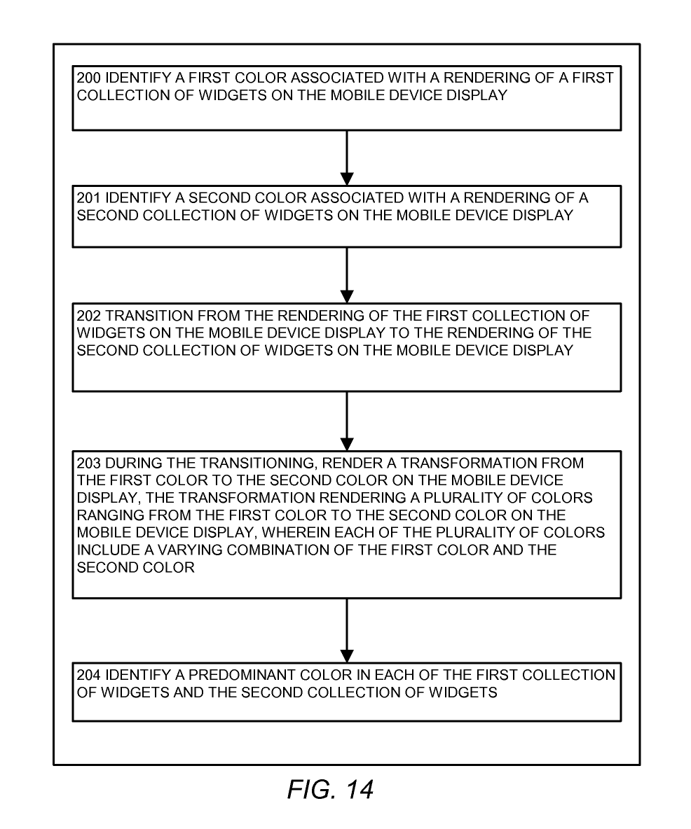

FIG. 14 is an embodiment of the steps performed by widget rendering process 140-2 when it identifies a first color/appearance associated with a rendering of a first collection of widgets 155-1 on the mobile device display 150.

In step 200, the widget rendering process 140-2 identifies a first color/appearance associated with a rendering of a first collection of widgets 155-1 on the mobile device display 150. FIG. 2 is an example screenshot of a collection of widgets 155-1 rendering a plurality of widgets 160-1, 160-2, 160-3, 160-4, and 160-5. The background of the collection of widgets 155-1 may have a color scheme so that a user 108 may easily identify the collection of widgets 155-1 when rendered on the mobile device display 150 with other collections of widgets 155-N.

In step 201, the widget rendering process 140-2 identifies a second color/appearance associated with a rendering of a second collection of widgets 155-2 on the mobile device display 150. FIG. 3 is an example screenshot of a collection of widgets 155-2 rendering a plurality of widgets 160-6, 160-7, 160-8, 160-9, and 160-10. FIG. 3 depicts a grouping of widgets 160-N related to calendars and clocks.

In step 202, the widget rendering process 140-2 transitions from rendering the first collection of widgets 155-1 on the mobile device display 150 to rendering the second collection of widgets 155-2 on the mobile device display 150. In an example embodiment, the transitioning occurs because a user 108 has scrolled from the first collection of widgets 155-1 to the second collection of widgets 155-2 in a panoramic view on the mobile device display 150 as depicted in FIG. 5.

During the transitioning, in step 203, the widget rendering process 140-2 renders a transformation from the first color/appearance to the second color/appearance on the mobile device display 150. The transformation renders a plurality of colors/appearances ranging from the first color/appearance to the second color/appearance on the mobile device display 150, wherein each of the plurality of colors/appearances include a varying combination of the first color/appearance and the second color/appearance. In an example embodiment, each of the plurality of colors has a color value including, but not limited to, a hue component or RGB value. This color value changes as the background color on the mobile device display 150 morphs from the first color/appearance (associated with the first collection of widgets 155-1) to the second color/appearance (associated with the second collection of widgets 155-2). To the user 108, the two colors/appearances appear to blend smoothly.

In an example embodiment, the widget rendering process 140-2 performs the transitioning from the first appearance to the second appearance when the second collection of widgets 155-2 is rendered on the mobile device display 150. In one example embodiment, the transitioning occurs quickly. In another example embodiment, the transitioning occurs at a speed slow enough to allow a user to view the transitioning.

In step 204, the widget rendering process 140-2 identifies a predominant color/appearance in each of the first collection of widgets 155-1 and the second collection of widgets 155-2. In an example embodiment, this predominant color/appearance appears as a background for the collections of widgets 155-N. This background may have a color scheme having a predominant color.

In an example embodiment, the widget rendering process 140-2 divides the first appearance into a plurality of first appearance pages, and divides the second appearance into a plurality of second appearance pages. During the rendering of the plurality of appearances, the widget rendering process 140-2 renders the plurality of first appearance pages followed by the plurality of second appearance pages. It is these pages (i.e., the plurality of first appearance pages and the plurality of second appearance pages) that are rendered with the varying combination of the first color/appearance and the second color/appearance to create the appearance of a smooth transition. In other words, the background of the first collection of widgets 155-1 is divided into a plurality of pages that are panoramically rendered on the mobile device display 150, and the same occurs for the background of the second collection of widgets 155-2.

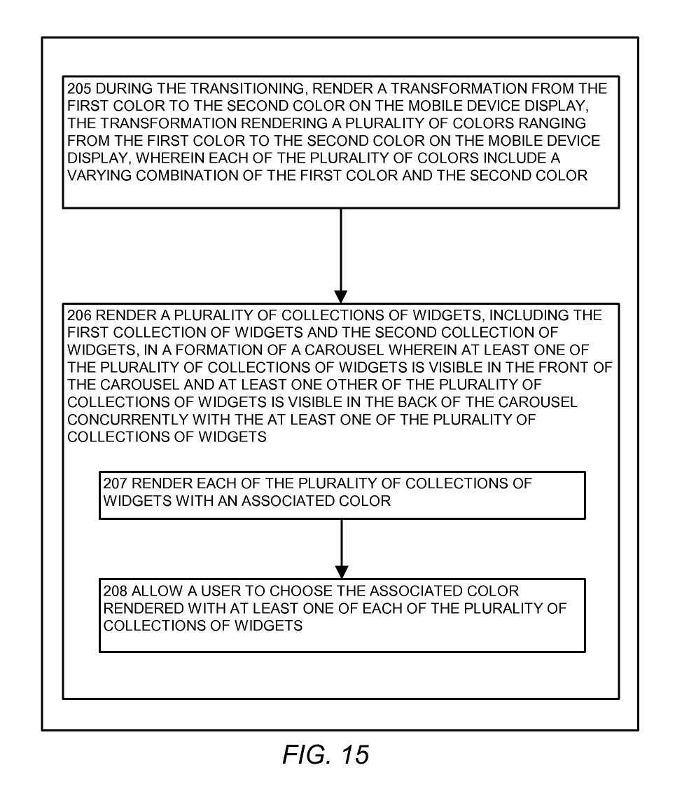

FIG. 15 is an embodiment of the steps performed by widget rendering process 140-2 when it renders a transformation from the first color/appearance to the second color/appearance on the mobile device display 150.

During the transitioning, in step 205, the widget rendering process 140-2 renders a transformation from the first color/appearance to the second color/appearance on the mobile device display 150. The transformation renders a plurality of colors/appearances ranging from the first color/appearance to the second color/appearance on the mobile device display 150. Each of the plurality of colors/appearances includes a varying combination of the first color/appearance and the second color/appearance. From the user's 108 viewpoint, the first color/appearance seamlessly morphs into the second color/appearance as the mobile device display 150 renders the transition from the first collection of widgets 155-1 to the second collection of widgets 155-2 in the panoramic view.

In step 206, the widget rendering process 140-2 performs the steps of identifying a first appearance, identifying a second appearance and transitioning for each pixel on the mobile device display 150. In another example embodiment, these steps are performed for every pixel in each container associated with the first collection of widgets 155-1 and the second collection of widgets 155-2.

In step 207, the widget rendering process 140-2 renders each of the plurality of collections of widgets 160-N with an associated color/appearance. In an example embodiment, each of the plurality of collections of widgets 160-N is rendered with an associated color/appearance to allow a user 108 to easily locate widgets 160-N when several widgets 160-N are rendered on the mobile device display 150. Each widget 160-N may have a unique color/appearance, or widgets 160-N that have similar functions (for example, system clocks, calendars, email, favorite contacts, etc.) may have similar associated colors/appearances. In this scenario, the user 108 can identify the function of the widget 160-N by the color/appearance. For example, all Internet related widgets 160-N might be associated with the color blue, (or a background that's predominantly blue) whereas all widgets 160-N related to work applications might be associated with the color green (or a background that's predominantly green).

In step 208, the widget rendering process 140-2 allows a user 108 to choose the associated color/appearance rendered with at least one of each of the plurality of collections of widgets 160-N. In an example embodiment, the widget rendering process 140-2 assigns a default associated color/appearance to each of the plurality of collections of widgets 160-N. In another example embodiment, the widget rendering process 140-2 allows a user 108 to choose the associated color/appearance. For example, a colorblind user 108 might need to choose specific colors so that he/she can distinguish between different collections of widgets 160-N.

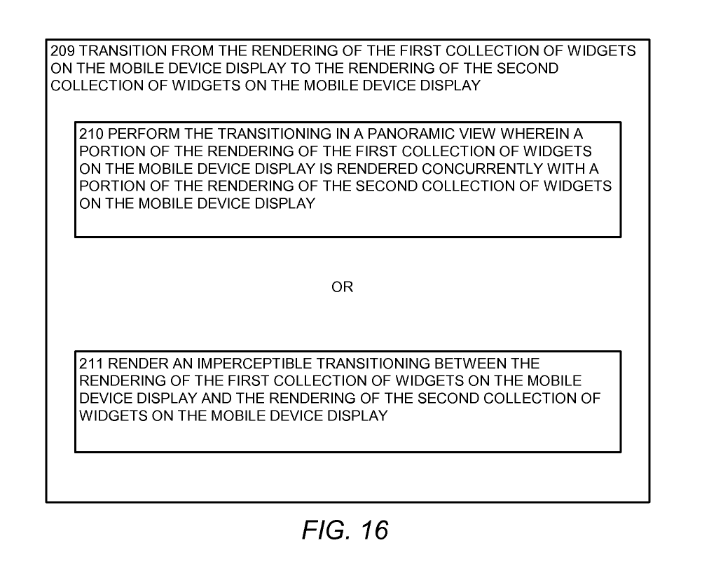

FIG. 16 is an embodiment of the steps performed by widget rendering process 140-2 when it the widget rendering process 140-2 transitions from the rendering of the first collection of widgets 155-1 on the mobile device display 150 to the rendering of the second collection of widgets 155-2 on the mobile device display 150.

In step 209, the widget rendering process 140-2 transitions from the rendering of the first collection of widgets 155-1 on the mobile device display 150 to the rendering of the second collection of widgets 155-2 on the mobile device display 150. In an example embodiment, a user 108 performs an action on the mobile device display 150 indicating he/she wishes to transition from a first collection of widgets 155-1 rendered on the mobile device display 150 to a second collection of widgets 155-2. The widget rendering process 140-2 responds by rendering a gradual, seamless transition from the first collection of widgets 155-1 to the second collection of widgets 155-2. The transitioning includes gradually and seamlessly transitioning from a first color/appearance associated with the first collection of widgets 155-1 to a second color/appearance associated with a second collection of widgets 155-2.

In an example embodiment, the color/appearance associated with each collection of widgets 155-N appears as a background. In another example embodiment, the color/appearance associated with each collection of widgets 155-N is painted each time the collection of widgets 155-N is rendered on the mobile device display 150. In other words, each time a collection of widgets 155-N is rendered on the mobile device display 150, the color/appearance is painted within a location on the mobile device display 150 that defines the boundaries of the collection of widgets 155-N, and then the individual widgets 160-N are painted within the boundaries of the collection of widgets 155-N.

In step 210, the widget rendering process 140-2 renders a transformation from the first appearance to the second appearance on the mobile device display when the second collection of widgets 155-2 is rendered on the mobile device display 150. In one example embodiment, the transformation occurs quickly. In another example embodiment, the transformation occurs slow enough for the user 108 to discern the transformation.

In an example embodiment, the widget rendering process 140-2 performs the transitioning in a panoramic view wherein a portion of the rendering of the first collection of widgets 155-1 on the mobile device display 150 is rendered concurrently with a portion of the rendering of the second collection of widgets 155-2 on the mobile device display 150. FIG. 5 depicts this concurrent rendering in Frame 2 where the mobile device display 150 displays portions of both the first collection of widgets 155-1 and the second collection of widgets 155-2. Frame 1 depicts the mobile device display 150 rendering the first collection of widgets 155-1. As the user 108 panoramically scrolls from the first collection of widgets 155-1 to the second collection of widgets 155-2, the mobile device display 150 renders both the first collection of widgets 155-1 and the second collection of widgets 155-2 concurrently as shown in Frame 2. As the user 108 continues to scroll panoramically, the mobile device display 150 gradually transitions between the first collection of widgets 155-1 and the second collection of widgets 155-2 until the mobile device display 150 displays the second collection of widgets 155-2 as depicted in Frame 3.

Alternatively, in step 211, the widget rendering process 140-2 renders an imperceptible transitioning between the rendering of the first collection of widgets 155-1 on the mobile device display 150 and the rendering of the second collection of widgets 155-2 on the mobile device display 150. To the user 108, there is a gradual transition from the first collection of widgets 155-1 to the rendering of the first collection of widgets 155-1 on the mobile device display 150 and the rendering of the second collection of widgets 155-2 on the mobile device display 150 including a gradual transition from the first color/appearance associated with the first collection of widgets 155-1 to the second color/appearance associated with the second collection of widgets 155-2.

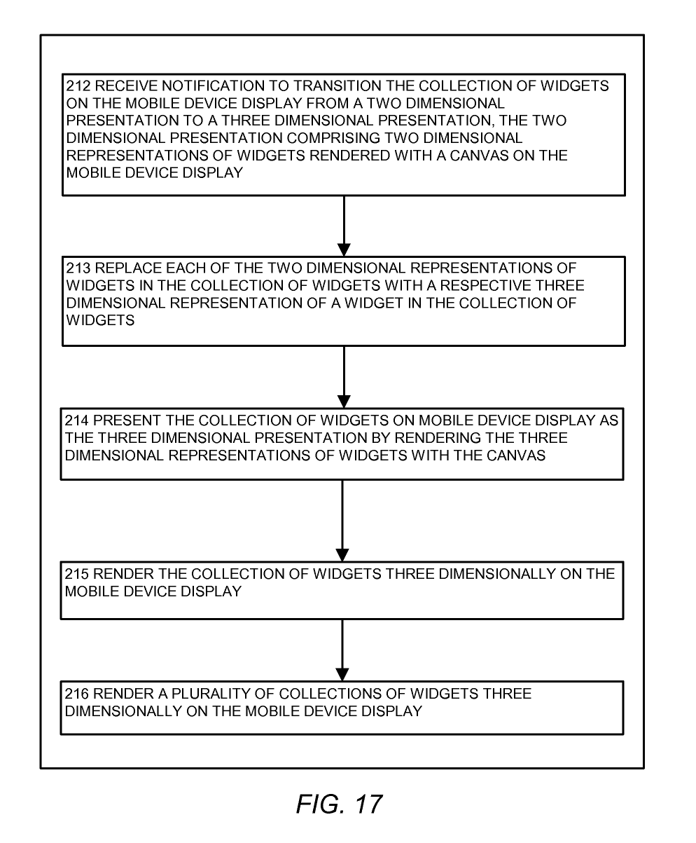

FIG. 17 is an embodiment of the steps performed by widget rendering process 140-2 when it receives notification to transition the collection of widgets 155-N on the mobile device display 150 from a two-dimensional presentation to a three-dimensional presentation.

In step 212, the widget rendering process 140-2 receives notification to transition the collection of widgets 155-N on the mobile device display 150 from a two-dimensional presentation to a three-dimensional presentation. The two-dimensional presentation comprises two-dimensional representations of collections of widgets 155-N rendered with a canvas on the mobile device display 150. FIG. 7 depicts a two-dimensional representation of a widget 160-4. FIG. 9 depicts a three-dimensional representation of the same collection of widgets 155-4. When viewed frontally, the widget 160-N in the two-dimensional representation of collection of widgets 155-4 (as depicted in FIG. 7) appear three dimensionally. However, when viewed from the side (i.e., when the mobile device 110 is rotated by a user 108 and viewed from a side angle), as depicted in FIG. 8, the widget 160-N on the collection of widgets 155-4 appear flat. In contrast, the three-dimensional representation of widgets 160-N on the collection of widgets 155-4 as depicted in FIG. 9 appear three dimensionally even when the collection of widgets 155-4 is rotated and viewed at a side angle.

In step 213, the widget rendering process 140-2 replaces each of the two-dimensional representations of widgets 160-N in the collection of widgets 155-4 with a respective three-dimensional representation of a widget 160-N in the collection of widgets 155-4. In other words, each of the two-dimensional representation widget 160-N depicted in FIG. 8 is replaced with a respective three-dimensional representation widget 160-N. Thus, the two-dimensional representation of widget 160-17 is replaced with a three-dimensional representation of widget 160-20, etc. In an example embodiment, the three-dimensional representation looks like the two-dimensional representation to the user. In other words, from a frontal view, the user 108 does not discern a difference between the two-dimensional representation and the three-dimensional representation of the widget 160-N. It is only when the user 108 rotates the mobile device 110 that the user 108 can distinguish between the two-dimensional representation and the three-dimensional representation of the widget 160-N.

In step 214, the widget rendering process 140-2 presents the collection of widgets 155-4 on mobile device display 150 as the three-dimensional presentation by rendering the three-dimensional representations of widgets 160-N with the canvas 180. The widget rendering process 140-2 renders the three-dimensional representations of widgets 160-N at a distance from the canvas 180.

In step 215, the widget rendering process 140-2 renders the collection of widgets 155-N three dimensionally on the mobile device display 150. FIG. 9 depicts how the widget rendering process 140-2 renders the widget 160-N three dimensionally on the canvas 180 of each of the collection of widgets 155-4.

In step 216, the widget rendering process 140-2 render a plurality of collections of widgets 160-N three dimensionally on the mobile device display 150. FIG. 10 depicts how the widget rendering process 140-2 renders each of the collection of widgets 155-3, 155-4, and 155-5 three dimensionally on the mobile device display 150. Each of the collections of widgets 155-N is rendered three dimensionally by rendering each respective set of widget 160-N three dimensionally on the respective canvas 180 of each of the collection of widgets 155-3, 155-4, and 155-5.

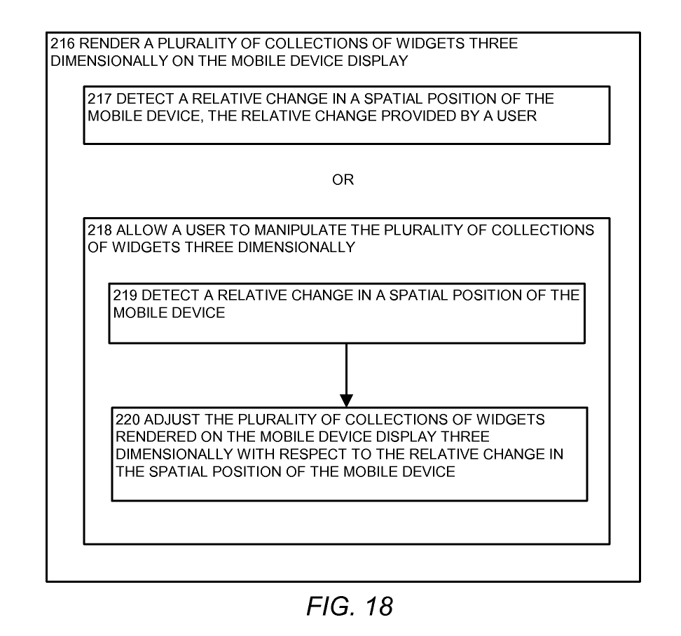

FIG. 18 is an continuation of an example embodiment of FIG. 17 of the steps performed by widget rendering process 140-2 when it renders a plurality of collections of widgets 160-N three dimensionally on the mobile device display 150. In step 217, the widget rendering process 140-2 detects a relative change in a spatial position of the mobile device 110 where the relative change provided by a user 108. In an example embodiment, the user 108 shakes the mobile device 110 or physically moves the mobile device 110, and the widget rendering process 140-2 transitions the collection of widgets 155-N from a two-dimensional representation to a three-dimensional representation and then renders a plurality of collections of widgets 155-N on the mobile device display 150. Thus, it requires very little effort on the part of the user 108 to transition the two-dimensional representation on the mobile device display 150 to a three-dimensional representation.

Alternatively, in step 218, the widget rendering process 140-2 allows a user 108 to manipulate the plurality of collections of widgets 160-N three dimensionally. In an example embodiment, a user 108 may scroll through the collection of widgets 155-N as depicted in FIG. 10 and FIG. 11. As the user 108 scrolls through the collection of widgets 155-N on the mobile device display 150, they scroll on and off the mobile device 110 three dimensionally.

In step 219, the widget rendering process 140-2 detects a relative change in a spatial position of the mobile device 110. In an example embodiment, a user 108 modifies the position of the mobile device 110. For example, the user 108 may rotate the mobile device 110 to see a side view of the plurality of collections of widgets 155-N.

In step 220, the widget rendering process 140-2 adjusts the plurality of collections of widgets 160-N rendered on the mobile device display 150 three dimensionally with respect to the relative change in the spatial position of the mobile device 110. In an example embodiment, as the widget rendering process 140-2 detects a relative change in the spatial position of the mobile device 110, the widget rendering process 140-2 renders the plurality of collections of widgets 155-N with respect to the relative change. In other words, as the user 108 rotates the mobile device 110 to view the mobile device display 150 from a side angle, the widget rendering process 140-2 responds by rendering the collection of widgets 155-N at a side angle. In an example embodiment, a gravity sensor (such as a G-sensor) detects the relative change in the spatial position of the mobile device 110. FIG. 9 depicts an example embodiment of a user 108 rotating the mobile device 110 to view the collection of widgets 155-4 from a side angle, and viewing the widgets 160-N three dimensionally.

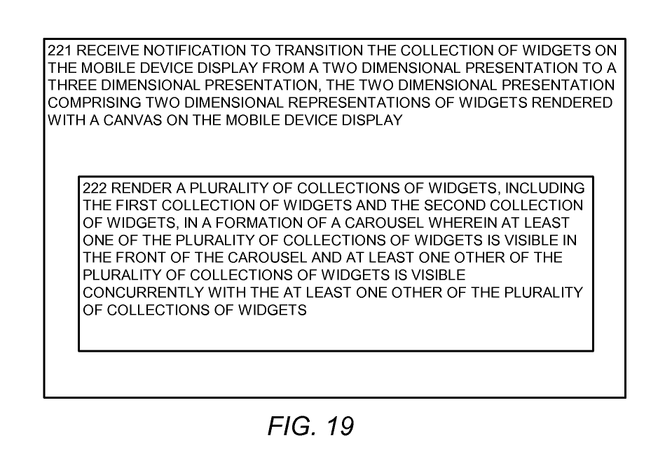

FIG. 19 is an embodiment of the steps performed by widget rendering process 140-2 when it receives notification to transition the collection of widgets 155-4 on the mobile device display 150 from a two-dimensional presentation to a three-dimensional presentation.

In step 221, the widget rendering process 140-2 receives notification to transition the collection of widgets 155-4 on the mobile device display 150 from a two-dimensional presentation to a three-dimensional presentation. The two-dimensional presentation comprises two-dimensional representations of widgets 160-N rendered with a canvas 180 on the mobile device display 150. FIG. 7 depicts an example embodiment of two-dimensional representation of widgets 160-N rendered on a canvas 180.

In step 222, the widget rendering process 140-2 renders a plurality of collections of widgets 160-N, including the first collection of widgets 155-1 and the second collection of widgets 155-10, in a formation of a carousel 165. In the carousel 165, at least one of the pluralities of collections of widgets 160-1 is visible in the front of the carousel and at least one other of the plurality of collections of widgets 160-10 is visible in the back of the carousel 165. The plurality of collections of widgets 160-10 is visible concurrently with the plurality of collections of widgets 160-1 visible in the front of the carousel 165. The user 108 may spin the carousel 165 to view other collection of widgets 155-N. The user may tap on the mobile device display 150 at the location of any collection of widgets 155-1 to invoke that collection of widgets 155-1.

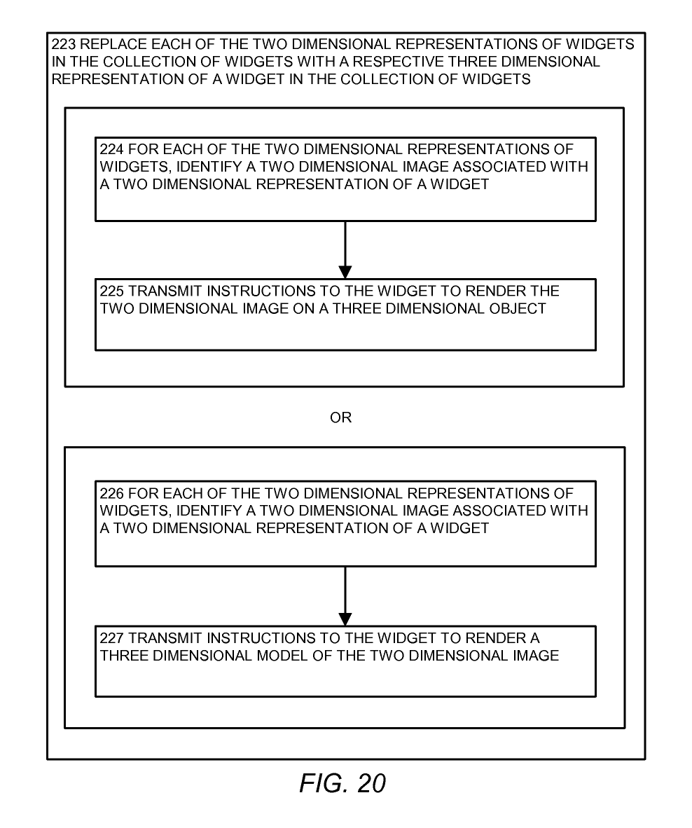

FIG. 20 is an embodiment of the steps performed by widget rendering process 140-2 when it replaces each of the two-dimensional representations of widgets 160-N in the collection of widgets 155-N with a respective three-dimensional representation of a widget 160-N in the collection of widgets 155-N.

In step 223, the widget rendering process 140-2 replaces each of the two-dimensional representations of widgets 160-N in the collection of widgets 155-N with a respective three-dimensional representation of a widget 160-N in the collection of widgets 155-N. FIG. 8 depicts a two-dimensional representation of widgets 160-N rendered on a mobile device display 150. FIG. 9 depicts a three-dimensional representation of widgets 160-N rendered on a mobile device display 150.

For each of the two-dimensional representations of widgets 160-N, in step 224, the widget rendering process 140-2 identifies a two-dimensional image associated with a two-dimensional representation of a widget 160-N. In an example embodiment, each widget 160-N is rendered on the mobile device display 150 as an icon. The icon is a two-dimensional image that represents the widget 160-N. When a user 108 selects (for example, taps the mobile device display 150 at the location of the icon), the widget 160-N is invoked.

In step 225, the widget rendering process 140-2 transmits instructions to the widget 160-N to render the two-dimensional image on a three-dimensional object. For example, the widget rendering process 140-2 transmits instructions to widget 160-16 to render a two-dimensional image on a box object, creating widget 160-23.

Alternatively, for each of the two-dimensional representations of widgets 160-N, in step 226, the widget rendering process 140-2 identifies a two-dimensional image associated with a two-dimensional representation of a widget 160-N. In an example embodiment, each widget 160-N is rendered on the mobile device display 150 as an icon. The icon is a two-dimensional image that represents the widget 160-N. When a user 108 selects (for example, taps the mobile device display 150 at the location of the icon), the widget 160-N is invoked.

In step 227, the widget rendering process 140-2 transmits instructions to the widget 160-N to render a three-dimensional model of the two-dimensional image. For example, the widget rendering process 140-2 transmits instructions to widget 160-17 to render a two-dimensional image on a sphere object, creating widget 160-20.

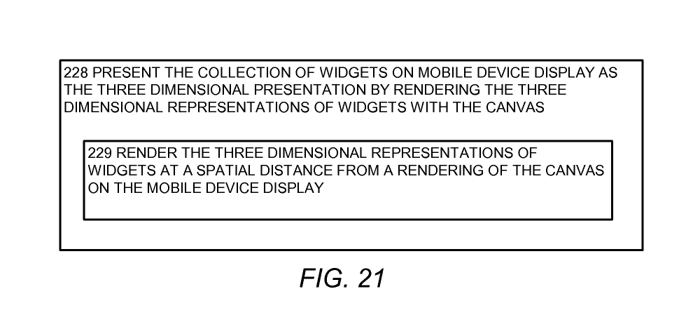

FIG. 21 is an embodiment of the steps performed by widget rendering process 140-2 when it presents the collection of widgets 155-N on mobile device display 150 as the three-dimensional presentation by rendering the three-dimensional representations of widgets 160-N with the canvas 180.

In step 228, the widget rendering process 140-2 presents the collection of widgets 155-N on mobile device display 150 as the three-dimensional presentation by rendering the three-dimensional representations of widgets 160-N with the canvas 180. In an example embodiment, the widget rendering process 140-2 transmits notification to the widget 160-N to paint themselves on the mobile device display 150 using three-dimensional representations of each of the widgets 160-N.

In step 229, the widget rendering process 140-2 renders the three-dimensional representations of widgets 160-N at a spatial distance from a rendering of the canvas 180 on the mobile device display 150. This spatial distance between the canvas 180 and the three-dimensional representation of widgets 160-N is depicted in FIG. 9.

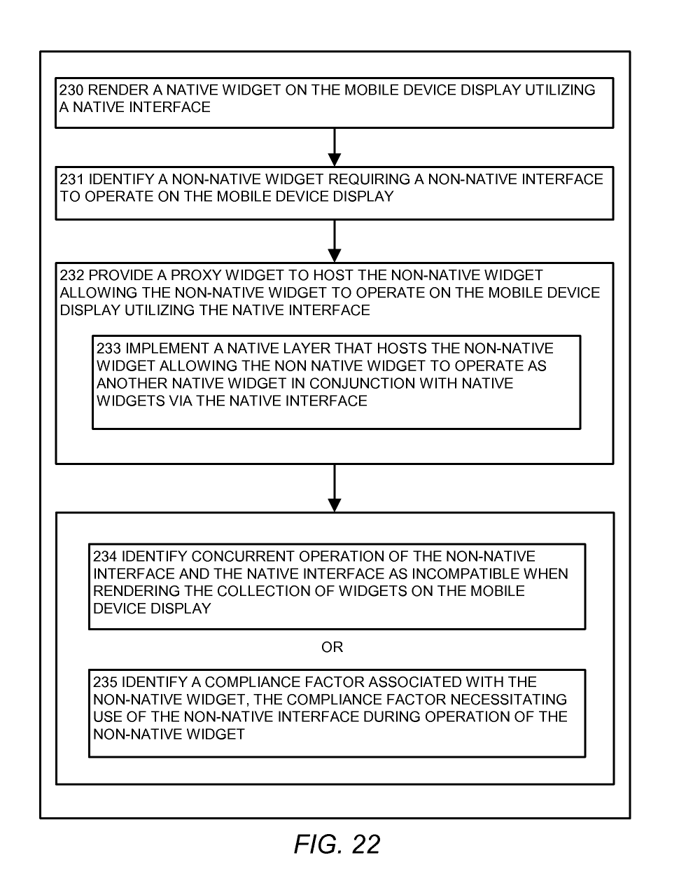

FIG. 22 is an embodiment of the steps performed by widget rendering process 140-2 when it renders a native widget 160-N on the mobile device display 150 utilizing a native interface.

In step 230, the widget rendering process 140-2 renders a native widget 160-N on the mobile device display 150 utilizing a native interface. In an example embodiment, native widgets 160-N are widgets 160-N written in the language of the platform of the mobile device 110 on which native widgets 160-N execute.

In step 231, the widget rendering process 140-2 identifies a non-native widget 160-N requiring a non-native interface to operate on the mobile device display 150. In an example embodiment, non-native widgets 160, for example, W3C compliant widgets 160-N, operate across several mobile device platforms making them versatile.

In step 232, the widget rendering process 140-2 provides a proxy widget 160-N to host the non-native widget 160-N allowing the non-native widget 160-N to operate on the mobile device display 150 utilizing the native interface. Typically, there is a trade off between native widgets 160-N and non-native widgets 160-N. Native widgets 160-N can provide more functionality whereas non-native widgets 160-N can execute across different platforms. The widget rendering process 140-2 provides a proxy allowing the non-native widget 160-N to perform as though it were a native widget 160-N.

In step 233, the widget rendering process 140-2 implements a native layer that hosts the non-native widget 160-N allowing the non-native widget 160-N to operate as another native widget 160-N in conjunction with native widgets 160-N via the native interface. In an example embodiment, the widget rendering process 140-2 implements a native layer that hosts the non-native widget 160-N. This allows the non-native widget 160-N to operate concurrently with the native widget 160-N using the same native interface that the native widget 160-N utilizes.

In step 234, the widget rendering process 140-2 identifies concurrent operation of the non-native interface and the native interface as incompatible with rendering the collection of widgets 155-N on the mobile device display 150. In an example embodiment, only one interface can operate on the mobile device 110. Each of the native widget 160-N and the non-native widget 160-N each require their own interface. The widget rendering process 140-2 identifies that these two interfaces cannot operate concurrently on the mobile device 110, and provides a proxy allowing the non-native widget 160-N to operate on the mobile device 110 as though it were a native widget 160-N.

In step 235, the widget rendering process 140-2 identifies a compliance factor associated with the non-native widget 160-N. The compliance factor necessitates use of the non-native interface during operation of the non-native widget 160-N. In an example embodiment, the non-native widget 160-N is a W3C compliant widget 160-N requiring its own compliant specific interface.

While computer systems and methods have been particularly shown and described above with references to configurations thereof, it will be understood by those skilled in the art that various changes in form and details may be made therein without departing from the scope disclosed herein. Accordingly, the information disclosed herein is not intended to be limited by the example configurations provided above.

What is claimed is:

1. A method of rendering a collection of widgets on a mobile device display, the method comprising:
identifying a first appearance associated with a rendering of a first collection of widgets on the mobile device display;
identifying a second appearance associated with a rendering of a second collection of widgets on the mobile device display;
transitioning from the rendering of the first collection of widgets on the mobile device display to the rendering of the second collection of widgets on the mobile device display; and
during the transitioning, rendering a transformation from the first appearance to the second appearance on the mobile device display, the transformation rendering a plurality of appearances ranging from the first appearance to the second appearance on the mobile device display, wherein each of the plurality of appearances includes a varying combination of the first appearance and the second appearance.

2. The method of claim 1 wherein rendering a transformation from the first appearance to the second appearance on the mobile device display comprises:
dividing the first appearance into a plurality of first appearance pages;
dividing the second appearance into a plurality of second appearance pages; and
rendering the plurality of appearances by rendering the plurality of first appearance pages followed by the plurality of second appearance pages.

3. The method of claim 1 comprising:
performing the steps of identifying a first appearance, identifying a second appearance and transitioning for each pixel on the mobile device display.

4. The method of claim 3 wherein rendering a plurality of collections of widgets comprises:
rendering each of the plurality of collections of widgets with an associated appearance.

5. The method of claim 4 comprising:
allowing a user to choose the associated appearance rendered with at least one of each of the plurality of collections of widgets.

6. The method of claim 1 wherein transitioning from the rendering of the first collection of widgets on the mobile device display to the rendering of the second collection of widgets on the mobile device display comprises:
rendering a transformation from the first appearance to the second appearance on the mobile device display when the second collection of widgets is rendered on the mobile device display.

7. The method of claim 1 wherein transitioning from the rendering of the first collection of widgets on the mobile device display to the rendering of the second collection of widgets on the mobile device display comprises:
rendering an imperceptible transitioning between the rendering of the first collection of widgets on the mobile device display and the rendering of the second collection of widgets on the mobile device display.

8. A method of rendering a collection of widgets on a mobile device display, the method comprising:
receiving notification to transition the collection of widgets on the mobile device display from a two-dimensional presentation to a three-dimensional presentation, the two-dimensional presentation comprising two-dimensional representations of widgets rendered with a canvas on the mobile device display;
replacing each of the two-dimensional representations of widgets in the collection of widgets with a respective three-dimensional representation of a widget in the collection of widgets;
presenting the collection of widgets on mobile device display as the three-dimensional presentation by rendering the three-dimensional representations of widgets with the canvas; and
rendering the collection of widgets three dimensionally on the mobile device display.

9. The method of claim 8 comprising:
rendering a plurality of collections of widgets three dimensionally on the mobile device display.

10. The method of claim 9 wherein rendering a plurality of collections of widgets three dimensionally on the mobile device display comprises:
detecting a relative change in a spatial position of the mobile device, the relative change provided by a user.

11. The method of claim 9 comprising:
allowing a user to manipulate the plurality of collections of widgets three dimensionally.

12. The method of claim 11 wherein allowing a user to manipulate the plurality of collections of widgets three dimensionally comprises:
detecting a relative change in a spatial position of the mobile device; and
adjusting the plurality of collections of widgets rendered on the mobile device display three dimensionally with respect to the relative change in the spatial position of the mobile device.

13. The method of claim 8 wherein receiving notification to transition the collection of widgets on the mobile device display from a two-dimensional presentation to a three-dimensional presentation comprises:
rendering a plurality of collections of widgets, including the first collection of widgets and the second collection of widgets, in a formation of a carousel wherein at least one of the plurality of collections of widgets is visible in the front of the carousel and at least one other of the plurality of collections of widgets is visible in the back of the carousel concurrently with the at least one of the plurality of collections of widgets.

14. The method of claim 8 wherein replacing each of the two-dimensional representations of widgets in the collection of widgets with a respective three-dimensional representation of widget in the collection of widgets comprises:
for each of the two-dimensional representations of widgets, identifying a two-dimensional image associated with a two-dimensional representation of a widget; and
transmitting instructions to the widget to render the two-dimensional image on a three-dimensional object.

15. The method of Claim wherein 8 replacing each of the two-dimensional representations of widgets in the collection of widgets with a respective three-dimensional representation of widget in the collection of widgets comprises:
for each of the two-dimensional representations of widgets, identifying a two-dimensional image associated with a two-dimensional representation of a widget; and
transmitting instructions to the widget to render a three-dimensional model of the two-dimensional image.

16. The method of claim 8 wherein presenting the collection of widgets on mobile device display as the three-dimensional presentation by rendering the three-dimensional representations of widgets with the canvas comprises:
rendering the three-dimensional representations of widgets at a spatial distance from a rendering of the canvas on the mobile device display.

17. A method of rendering a collection of widgets on a mobile device display, the method comprising:
rendering a native widget on the mobile device display utilizing a native interface;
identifying a non-native widget requiring a non-native interface to operate on the mobile device display; and
providing a proxy widget to host the non-native widget allowing the non-native widget to operate on the mobile device display utilizing the native interface.

18. The method of claim 17 comprising:
identifying concurrent operation of the non-native interface and the native interface as incompatible when rendering the collection of widgets on the mobile device display.

19. The method of claim 17 comprising:
identifying a compliance factor associated with the non-native widget, the compliance factor necessitating use of the non-native interface during operation of the non-native widget.

20. The method of claim 17 wherein providing a proxy widget to host the non-native widget comprises:
implementing a native layer that hosts the non-native widget allowing the non-native widget to operate as another native widget in conjunction with native widgets via the native interface.
